(19) United States
(12) Patent Application Publication
(10) Pub. No.: US 2017/0286911 A1
(43) Pub. Date: Oct. 5, 2017

(54) Electronic Project Management System

(71) Applicant: Lynch & Associates - Engineering Consultants, LLC, New Berlin, WI (US)

(72) Inventor: Gary P. Randle II, Lake Geneva, WI (US)

(21) Appl. No.: 15/471,084

(22) Filed: Mar. 28, 2017

Related U.S. Application Data
(60) Provisional application No. 62/318,256, filed on Apr. 5, 2016.

(51) Int. Cl. G06Q 10/10; G06Q 50/08; G06Q 10/06; H04L 29/08

(52) U.S. Cl. CPC G06Q 10/103; H04L 67/18; G06Q 50/08; G06Q 10/06313

(57) ABSTRACT

An electronic project management system is configured to prepare a map including a plan having multiple activities distributed over a geographic area and link a parameter characterizing a project feature from a portable electronic device in the field to an activity of the plan. The parameter is linked to the activity using a determined coordinate location from the portable electronic device. Reports can then be transmitted in real-time, from the project site, to a centralized computer system, along with precise location data provided by the device.

### CROSS-REFERENCE TO RELATED APPLICATION(S)

This application claims priority to U.S. Provisional Patent Application No. 62/318,256, entitled “System for Managing Construction Projects,” filed Apr. 5, 2016, which is incorporated herein by reference.

### FIELD OF THE INVENTION

The present invention is directed to an electronic project management system, and more particularly, to an electronic project management system configured to prepare a map including a plan having multiple activities distributed over a geographic area and link a parameter characterizing a project feature from a wireless communication device to an activity of the plan based on the location of the device.

### BACKGROUND OF THE INVENTION

Civil projects, such as construction projects, maintenance projects, and the like, are important to the economic growth of communities by providing expansion of existing infrastructures and, in many cases, new infrastructures altogether. Public spending on such projects continues to grow and, as a result, the importance of tracking such projects to ensure adequate progress, use of appropriate or designated materials, timely completion, and/or completion according to a plan continues to grow. Tracking such projects typically involves many different personnel, commonly associated with different aspects of a project, performing site inspections and generating reports characterizing various aspects of the project. Personnel oftentimes generate and collect such reports at multiple project sites and/or locations, and on a given day, at times convenient for the personnel, transmit such reports to a central database which, in turn, is manually updated and made available for third party inspection and/or verification.

However, as personnel oftentimes visit multiple project sites and/or locations before providing status information, such information can be lost, incorrectly uploaded when transmitted, and/or delayed. Consequently, there is a need for a project management system which facilitates better information communication and retention, more timely remote and/or shared access to acquired information, and more readily facilitates comparison of acquired information with plan information.

### SUMMARY OF THE INVENTION

An electronic project management system is configured to prepare a map including a plan having multiple activities distributed over a geographic area and link a parameter characterizing a project feature from a portable electronic device in the field to an activity of the plan. The parameter is linked to the activity using a determined coordinate location from the portable electronic device. Reports can then be transmitted in real-time, from the project site, to a centralized computer system, along with precise location data provided by the device. In addition, various media, such as pictures, sounds and/or video, which may be collected via sensors associated with the device, such as a camera and/or microphone, can be transmitted with the reports for greater monitoring. As a result, the centralized computer system can map the reports to their respective locations in real-time to efficiently track and manage the project with minimal information loss and greater accuracy than is achievable with other systems.

In one aspect, a system and method can be provided for gathering, recording, analyzing, managing and/or sharing data from a project site, such as a construction or maintenance project site. The system can include a methodology and process, an open source interface for data collection, an open source “cloud based” storage device, and a public data consumer interface. The open source interface for data collection can interface with one or more “cloud based” storage devices, which can be located on-site or off-site and which can reflect data produced on-site associated with the project. The storage device can store data produced by one or more data producers, which may be received using the open source data collection interface. The public data consumer interface may interface with one or more data consumers, and the data consumer interface may provide access to data stored in the storage device.

A map can be pulled or created from a mapping source of geographical information system, such as ArcGIS and/or ArcReader, based on an area where construction is to take place. Existing infrastructure can be added to the map using known GIS applications, such as ArcGIS developed by Environmental Systems Research Institute (ESRI). A legend can also be created on the map, through the GIS application, such as for project materials, lines and the like to be installed during construction and/or maintained. GPS survey data, AutoCAD or other computer aided drafting design information, line work and/or other applicable information on installed materials can also be added to the map.

Various attribute tables and templates can be developed, such as through the GIS application, for construction and/or maintenance information to be logged into the GIS map format (for example, various daily status and/or milestone or completion reports). Entry of forms can be made through a fixed, desktop computer or a mobile device in the field. Upon completion of a form, a point can be automatically saved and updated to the GIS application platform as soon as a “close” button is clicked. This information can then be viewed from any computer with password access to the project mapping. Field personnel can see the same information in a mobile format through the GIS application, such as via a collector application installed on a portable personal electronic device such as a laptop, smart phone, or tablet.

When using mobile devices, the location information from the mobile device can be taken and placed at a point on the map in the appropriate location. Pictures, videos, and/or other attachments can be added to the report as well. Upon clicking “submit,” all information can be immediately viewable on any platform by any user preferably having authorized password access.

Specifically then, one aspect of the present invention provides an electronic project management system including: a portable electronic device having a position sensor, a user interface and a wireless communication system; and an electronic host system in communication with the portable electronic device. The electronic host system having a processor executing a program stored in a non-transient medium operable to: (a) prepare a map including a plan having multiple activities distributed over a geographic area; (b) receive a message from the portable electronic device, the message including: (i) a location determined by the position sensor; (ii) a timestamp for the message; and (iii) a parameter characterizing a project feature; (c) determine a coordinate location on the map based on the location determined by the position sensor; and (d) link the parameter characterizing the project feature to an activity of the plan using the determined coordinate location.

Another aspect may provide a system for managing a construction project comprising: a portable electronic device including a position sensor; a user interface; and a wireless communication system in which the portable electronic device is operable to send a message to a network via the wireless communication system, the message including a location determined by the position sensor and a parameter characterizing a construction feature at the location provided by the user interface; and an electronic host system configured to communicate with a network, the electronic host system having a processor executing a program stored in a non-transient medium operable to: receive a message from the portable electronic device; and link the parameter characterizing the construction feature in the message to a coordinate location on a map, the coordinate location corresponding to the location in the message.

Another aspect may provide a method for managing a construction project using a portable electronic device including a position sensor, a user interface and a wireless communication system and an electronic host system configured to communicate with a network. The method may include: (a) sending a message from the portable electronic device to the electronic host system via the wireless communication system and the network, the message including a location determined by the position sensor and a parameter characterizing a construction feature at the location provided by the user interface; and (b) linking the parameter characterizing the construction feature in the message to a coordinate location on a map, the coordinate location corresponding to the location in the message.

Other aspects, objects, features, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout.

FIG. 1 is an exemplary system for electronic project management including one or more portable electronic devices and an electronic host system in accordance with an aspect of the invention;

FIG. 2 is an exemplar map with a plan having multiple activities distributed over a geographic area which can be used in the electronic project management of FIG. 1;

FIG. 3 is an exemplar report or message which can be provided in connection with the electronic project management of FIG. 1;

FIG. 4 is the report or message of FIG. 3 linked to a coordinate location on the map of FIG. 2 in accordance with an aspect of the invention;

FIG. 5 is the map of FIG. 2 which can be viewed to retrieve reports or messages linked to coordinate locations in accordance with an aspect of the invention;

FIG. 6 is an exemplar process flow for an electronic project management method in accordance with an aspect of the invention;

FIG. 7 is an exemplar dashboard which can be displayed by the electronic project management of FIG. 1;

FIG. 8 is the dashboard of FIG. 7 in which the report or message of FIG. 3 can be viewed among other reports or messages; and

FIG. 9 is an exemplar map with a plan having multiple activities distributed over a geographic area in accordance with another aspect of the invention.

### DETAILED DESCRIPTION OF THE DRAWINGS

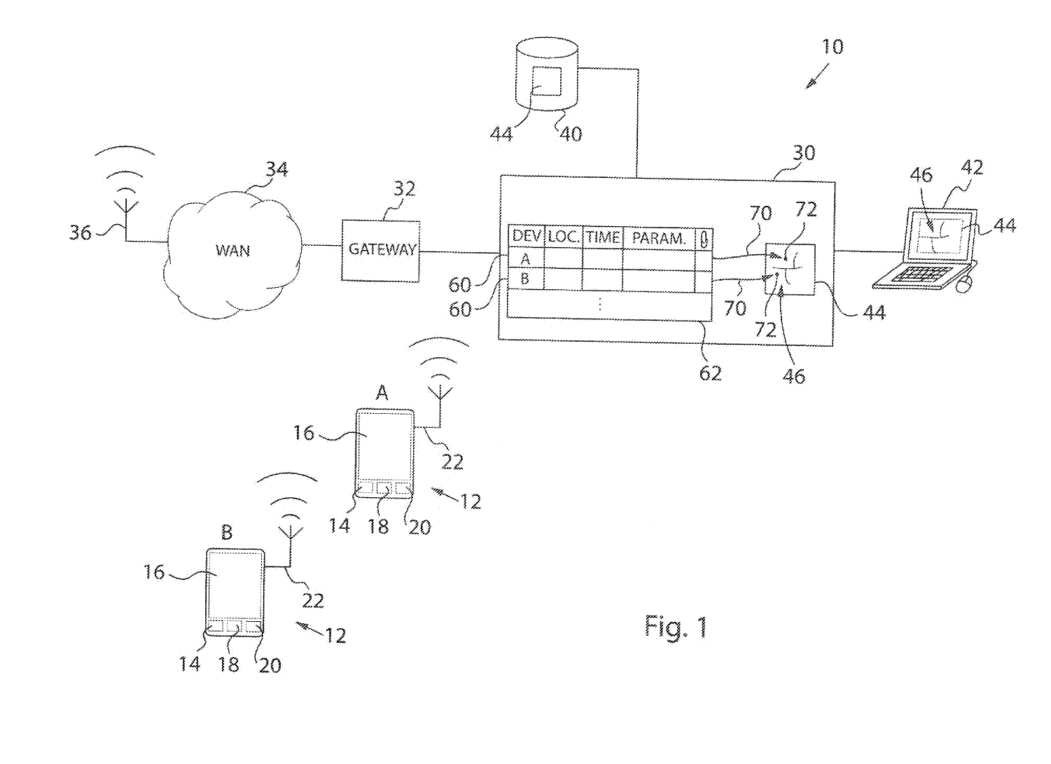

Referring now to FIG. 1, an exemplar electronic project management system 10 for managing a construction project is provided in accordance with an aspect of the invention. The system 10 can include one or more portable electronic devices 12 (shown as devices “A” and “B” by way of example). The portable electronic devices 12 can each include, among other things, a position sensor 14, a user interface 16, a wireless communication system 18 and device sensors 20. The position sensor 14 can be implemented by a Global Positioning System (GPS) or other network coordination system and can achieve geographic coordinate location accuracy for the portable electronic device 12 within a meter, and preferably, within closer dimensions, such as feet, inches, or centimeters. The user interface 16 can include a touchscreen, buttons, microphone and/or camera accessible by a user. The wireless communication system 18 can include an internal and/or external antenna 22 which can permit wireless communication with a network, such as via cellular, Wi-Fi, and/or satellite data communication. The device sensors 20 can include, for example, cameras and/or microphones for collecting various media, such as pictures, sounds and/or video. The portable electronic devices 12 can be, for example, smart phones, tablets, laptops and/or other portable computing devices.

The system 10 can also include an electronic host system 30 configured to communicate with a network. The electronic host system 30 can be a “cloud based” computing system having a processor, memory and storage device. The electronic host system 30 can be in communication with a router or gateway 32 via a Local Area Network (LAN). The router or gateway 32 can implement firewall security and can allow further communication over a Wide Area Network (WAN) 34 or the Internet, which can further allow wireless communication with the portable electronic devices 12 as known in the art, such as via a WAN service antenna 36.

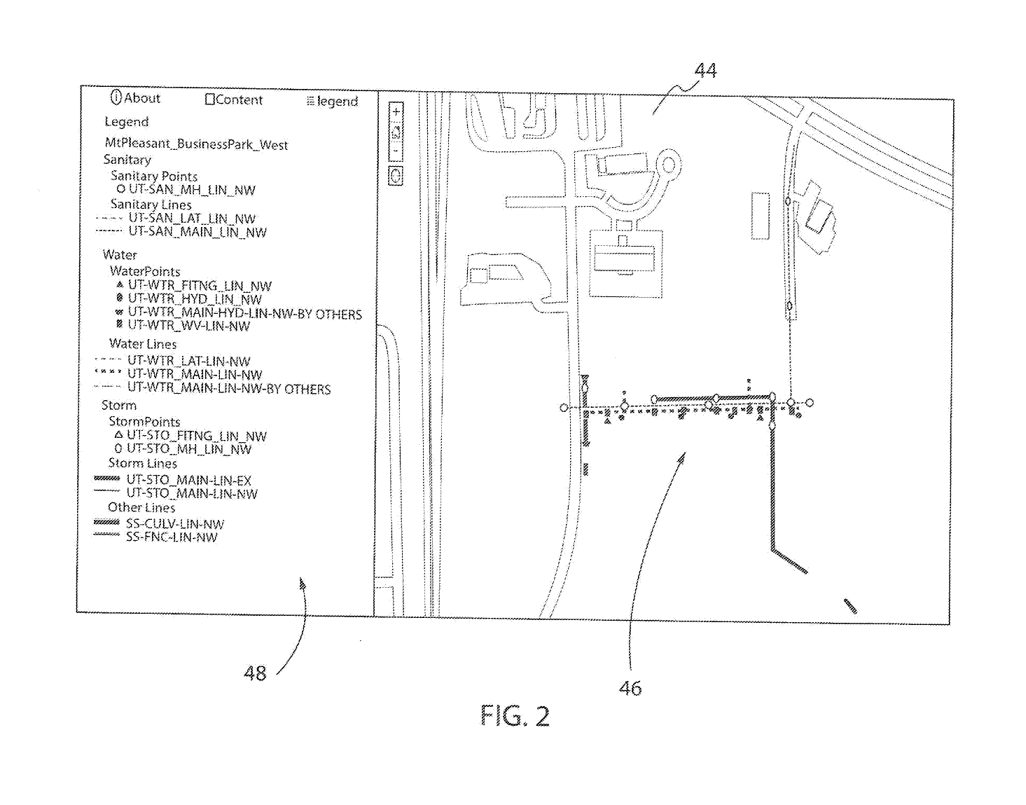

In one aspect, the electronic host system 30 can also communicate with a mapping database 40 and/or a computer 42 having a user input, processor, memory, storage and display, such as via the LAN (as shown) or WAN. The mapping database 40 can store multiple geographic maps 44, which can be Geographic Information System (GIS) maps. With additional reference to FIG. 2, the computer 42 can prepare a particular map 44 from the mapping database 40 with a plan 46 having activities distributed over a geographic area for a construction or maintenance project site or location provided on the map 44. As used herein, an “activity” refers to any feature of a plan which can be implemented in the field. The computer 42 can use a known GIS application, such as ArcGIS developed by Environmental Systems Research Institute (ESRI), and/or a known design application, such as AutoCAD developed by Autodesk, Inc. Although shown as an exemplary geographical map interface, it is further appreciated that the mapping database could include other maps such as geospatial and/or topographical maps, structural maps, or facility structure plans.

Regardless of the modality or origin associated with the mapping data, a legend 48 can also be created on the map for the activities, through the GIS application. Such activities can include, for example, delivery of project materials, implementation of lines, such as sewers, surface water drainage structures, potable water, curb, electrical, and the like, construction of features, such as fences, roads, buildings, structures, lights, walls, walkways, and the like, maintenance of features, such as trimming, cutting, planting, seeding, fertilizing, and/or otherwise attending to landscape, painting, laying of materials, snow removal, and the like. GPS survey data, AutoCAD design information, line work, and/or other applicable information on material and/or material specifications, to be installed can also be added to the map 44. It will be appreciated that various activities of a plan distributed over a geographic area can be provided, and various configurations of software and/or processing distribution can be realized between the electronic host system 30, the mapping database 40 and/or the computer 42 as known in the art.

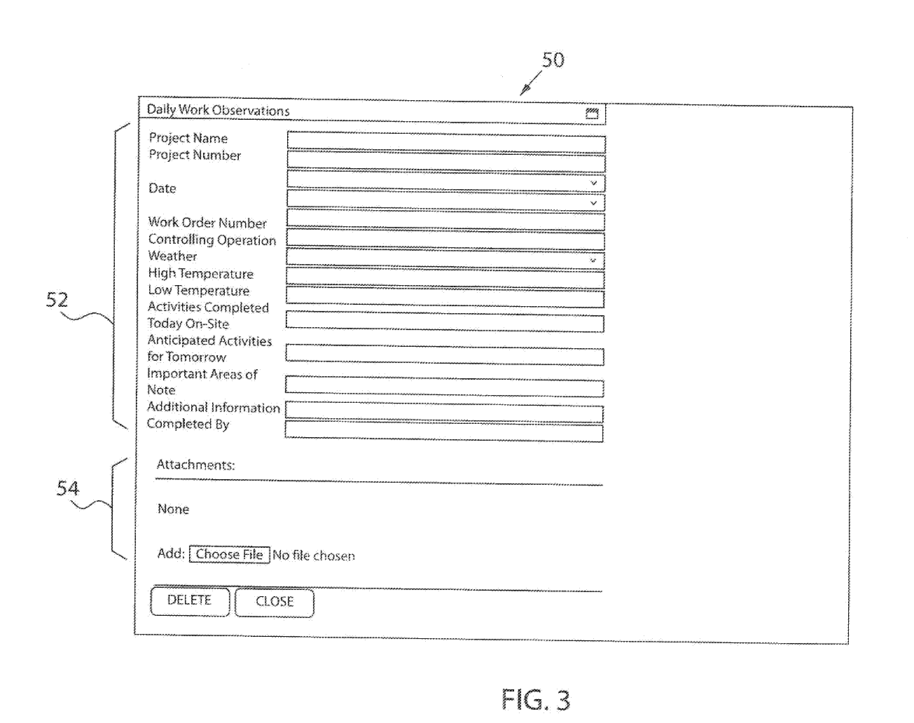

In operation, with additional reference to FIG. 3, one or more portable electronic devices 12 can be used to generate in real-time various types of reports 50, which a user can select, at a discrete facility or a construction or maintenance (project) site provided on the map 44. The reports 50 can be part of a common, open source interface for data collection from widely varying sources. The portable electronic devices 12 can capture various parameters 52 characterizing one or more project features at the project site location, such as, by way of example, weather conditions, activities completed this day, anticipated activities for the next day, important areas of note, labor/equipment involved, material quantities involved, change orders, price/cost adjustments, and the like. The parameters 52 characterizing the project features can be captured using the user interface 16. In addition, the portable electronic devices 12 can capture various media, such as pictures, sounds and/or video, which can relate to the parameters 52 characterizing the project features. Such media can be collected using the device sensors 20, and the media can be directly attached to the report 50 via various attachment links 54. Preferably, the generation of such various media are positionally and temporally linked relative to the map and, once uploaded, available for third party inspection and/or manipulation as disclosed further below.

The portable electronic devices 12, in turn, can then send the report 50, such as immediately upon clicking “submit” button, thereby routing a message 60 to the electronic host system 30 for viewing on any platform by any user with password access. The electronic host system 30 can receive the message 60, for example, through a common, open source interface as part of “cloud based” storage system. The message 60 can be sent, for example, via the wireless communication system 18 to the WAN 34. In the event no wireless communication protocol is available, it is envisioned that any unsent messages can be cached for later transmission when a suitable wired and/or wireless communication can be achieved as disclosed below. Alternatively, it is further envisioned that, should the wireless connectivity of the remote appliances be rendered inoperative, such messages can be sent via a physical electrical connection with other peripheral electronic devices connected via a wired and/or wireless connection methodology to host system 30.

The electronic host system 30, in turn, can store the message 60 in a message queue 62 containing multiple other messages 60. Each message 60 can include, for example, a portable electronic device identifier (such as a specific device user name, device numerical identifier, or alphanumeric identifiers such as “A” or “B”), a location of the portable electronic device determined by the position sensor 14 (unless manually provided), a timestamp which can include a precise date and/or time of transmission of the message and/or acquisition of the discrete data, various parameters characterizing one or more project features at the project site location which can be provided by the user interface 16 and/or media attachments, such as pictures, sounds and/or video, which can relate to the parameters characterizing the project features.

The electronic host system 30, in turn, can establish links 70 between the messages 60, including the various parameters characterizing one or more project features at the project site location, and coordinate locations 72 on the map 44. The links 70 can be established to correspond to the location of the portable electronic device determined by the position sensor 14 (unless manually provided) in the message 60. The links 70 can correspond the various parameters characterizing the one or more project features to an activity of the plan using a determined coordinate location. Accordingly, multiple coordinate locations 72 can be displayed.

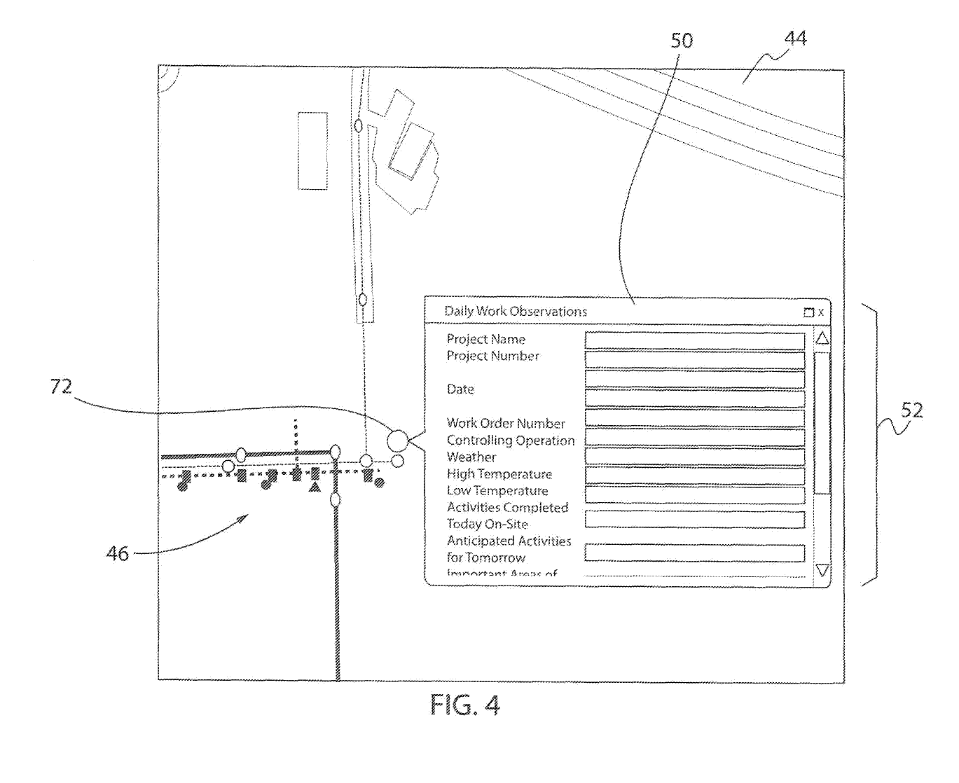

As shown by way of example in FIG. 4, the electronic host system 30 can execute to display, and/or the computer 42 can execute to display, a report 50 of a particular message 60 at a coordinate location 72 corresponding to the location of the portable electronic device 12 which provided the message 60. In operation, a user can select a desired coordinate location 72 to retrieve more information, such as the contents of the report 50 and/or media attachments.

In addition, features of design or maintenance plan 46 and/or coordinate locations 72 can be provided on various discrete layers on the map 44, such that certain layers can be activated (displayed) while other layers are deactivated (hidden from display) based on user selectable criteria. For example, all coordinate locations 72 having a common timestamp (such as a date) can be displayed along with the related plan 46, while all other coordinate locations 72 can be hidden from display. Moreover, shapes and color coding can be applied to increase ease of filtering and displaying. It will be appreciated that a variety of filtering and displaying configurations are possible and accordingly within the scope of the invention.

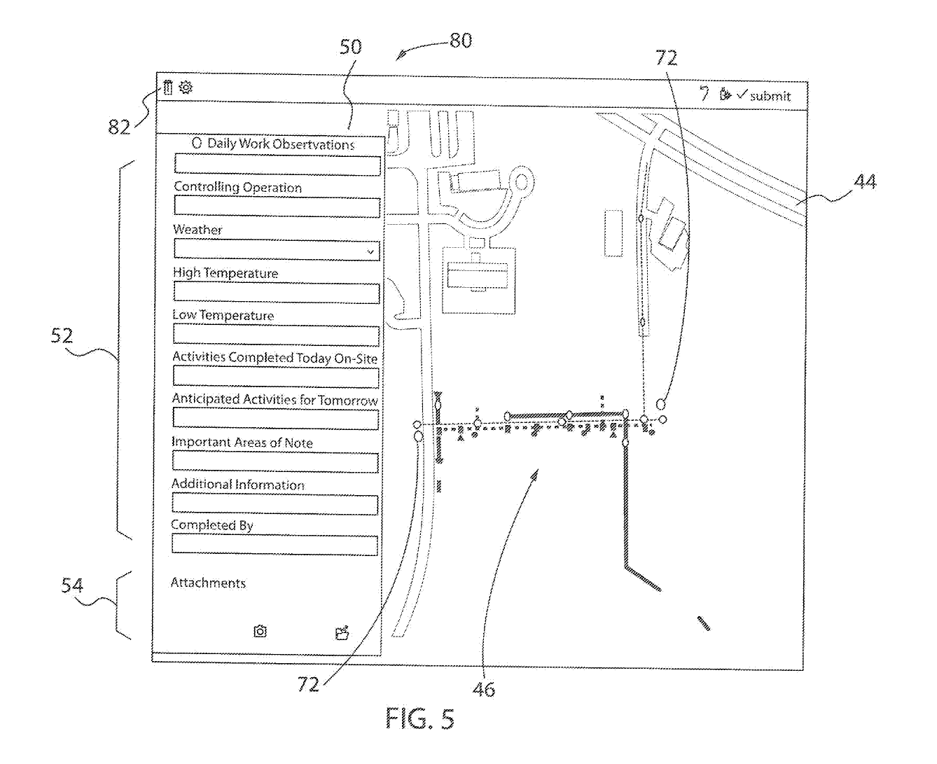

With additional reference to FIG. 5, the map 44 can be displayed to a screen 80 (which can be provided by the portable electronic device 12, the electronic host system 30, and/or the computer 42, and/or the displays associated with other authorized third party viewers) along with a toolbar 82. The toolbar 82 can allow for various actions within the application environment, such as opening/viewing reports 50, attachments and other content, selecting various layers for filtering and displaying, such as areas of the plan 46 and/or coordinate locations 72, entering new reports 50, attachments and other content associated with discrete coordinate locations 72, modifying and/or indicating deviations associated with the plan 46, controlling access to stored data, editing and/or deleting, and the like. For instance, some users, such as field technicians or the like, can have access to add and/or view data, while a trade-person's access can be limited solely to the information associated with their aspects of the project, and while general contractors, plan designers, project owners, inspectors and/or other higher level project personnel can have unrestricted access to the acquired data, aside from possible manipulation of the plan during development of the project without explicit authorization from hierarchical project manager or the like for requested manipulations or deviations from the plan.

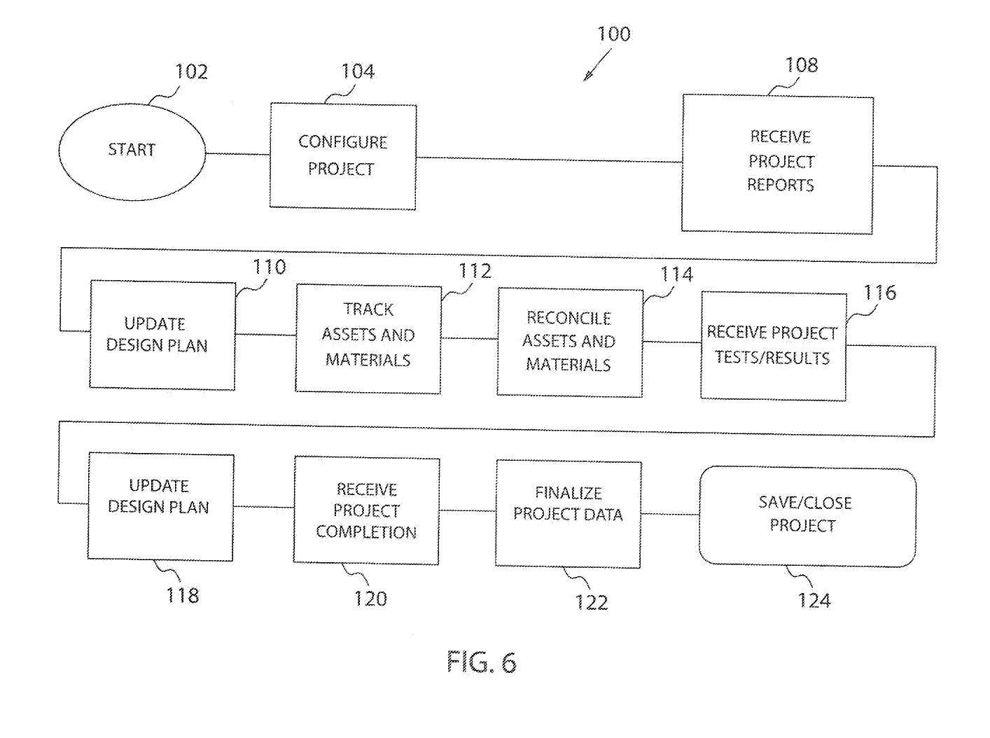

An exemplar process flow 100 is provided in FIG. 6 for a method for managing a project in accordance with an embodiment of the invention. In the process flow 100, in block 102, a construction or maintenance project can begin, such as with a project bid acceptance and being ready for construction or maintenance. In block 104, files can be setup, which can use the aforementioned templates, such as in a cloud based electronic host system, for uploading of information at the end of each day. In block 106, construction or maintenance can begin, and in block 108, daily project documentation can be completed throughout the project with pictures, videos, and construction conditions/changes provided in real-time. In block 110, changes to the plan can be noted, such as in different color line work, and uploaded in real-time.

In block 112, quantity tracking of installed materials can be provided through GPS locations as collected by the portable electronic devices in real-time. In block 114, contractor/engineer/client quantity reconciliation from quantities provided by GPS shots can be queried, such as from a table in ArcGIS, with sub-meter accuracy, and preferably sub-centimeter accuracy. In block 116, contract documentation, such as testing reports, results, requests for information data (RFI's), request for quote information (RFQ's), from plan to actual “Change Management”, and the like, can be recorded, logged, and delivered, such as through an ArcGIS environment, with templates, attachments, videos, photos, and the like in real-time. In block 118, changes to the plan can be noted, such as in a different color line work, and uploaded in real-time. It is further appreciated that the electronic project management system can be configured to communicate change requests from the field in real time, or substantially close thereto, to those parties having change management authority so as to reduce project delays associated with unforeseen deviations from the plan associated with discrete project completion and the one or more trades associated therewith. In block 120, project completion documentation can be delivered through ArcGIS in real-time, signaling work is complete. In block 122, documentation can be reviewed one last time by a client before being saved into the clients system, such as an ArcGIS master map, for viewing by all users with granted permissions. Finally, in block 124, the completed project can be saved as a master file which includes the discrete information and data associated with the actual completed project and subsequently closed but accessible for future assessment and inspection.

Although described above as what can be described more so as an infrastructure related project, it is appreciated that the project status monitoring system disclosed herein can be utilized to monitor, assess, and memorialize the status and/or configuration of more facility centric projects. For instance, it is envisioned that the system disclosed herein can be utilized to effectuate remote monitoring and authorization of change orders or the like of facility or environment plumbing, wiring, heating and cooling installation and other such facility specific systems. It is further appreciated that the various node functionalities disclosed above can be used to effectuate, identify, or designate asset specific information. For instance, when utilized to assess infrastructure projects, fire hydrants, transformers, castings, man-holes, catch basin structures and the like can be readily identified by manufacturer specific information such as manufacturer, manufacture date, lot or serial numbers etc. In a facility specific type applications, other assets such as fixtures, valves, controllers, panels, etc. can be readily identified by similar such information and/or data such that, regardless of the building or installation environment, the status and/or service parameters associated with the discrete assets can be readily determined and memorialized for service or the like for the operational life of the underlying system as well as being cognizant of warranty information or the like. Such considerations facilitate the real-time and remote monitoring of the status and/or operability of the underlying systems thereby improving the efficiency with which such systems can be constructed, maintained, and memorialized.

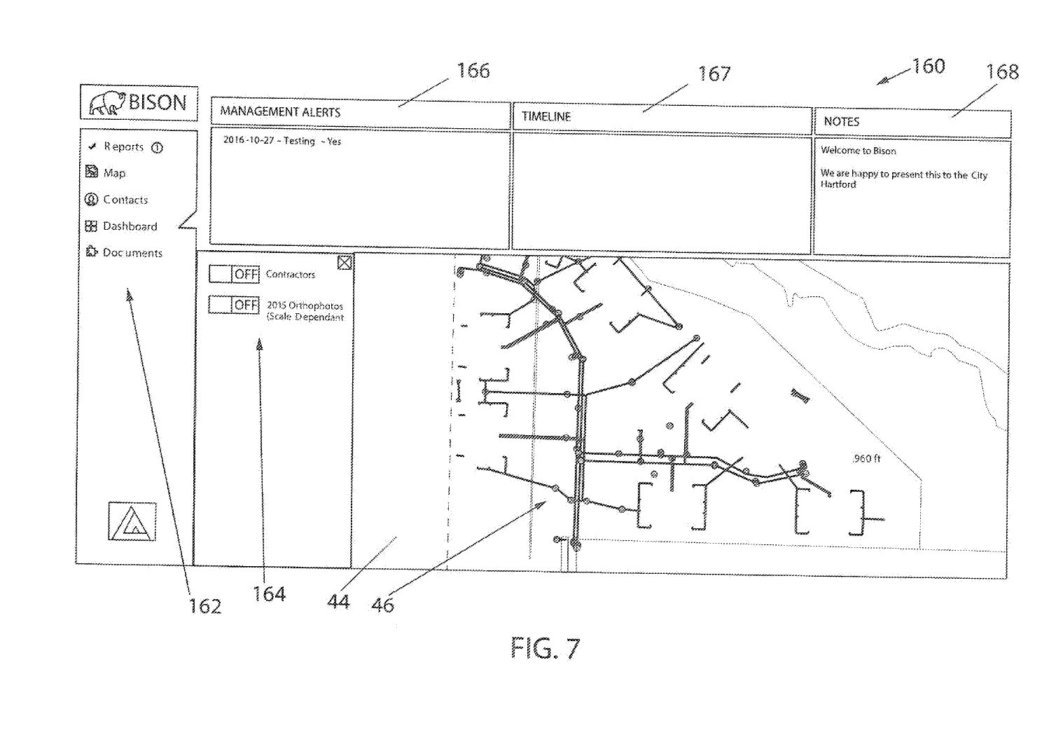

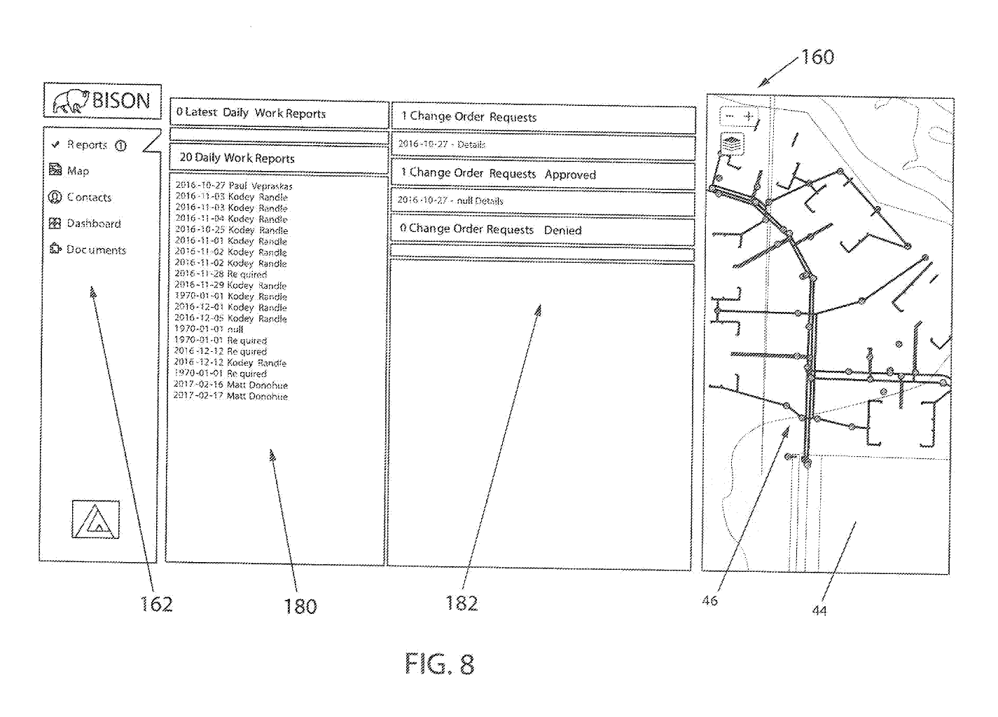

Referring now to FIG. 7, an exemplar dashboard 160, which can be displayed by the system 10, is provided in accordance with an aspect of the invention. The dashboard 160, which could be displayed to the computer 42, or in a similar version to a portable electronic device 12, can include a menu bar 162 for selecting various aspects of a project, such as a view of a map 44 pertinent to the project, a view of a plan 46, overlaid with respect to the map 44, having activities pertinent to the project, a view of reports 50 pertinent to the activities, a view of contacts for the project, and a view of all documents related to the project. One or more of the foregoing can be viewed as being plotted at coordinate locations in various layers of the map 44, which layers can be activated or deactivated via layer control 164. In addition, the dashboard 160 can provide quick views for management alerts 166, a timeline 167 for implementation of activities of the plan 46 with respect to the map 44, and/or notes 168 which can be posted for activities of the plan 46 with respect to the map 44. With additional reference to FIG. 8, in one view, the dashboard 160 can be expanded to display a first listing 180 for all reports 50 which may be relevant to the project, as well as a second listing 182 for all change order requests, approvals and/or denials with respect to the plan 46, which may be relevant to the project.

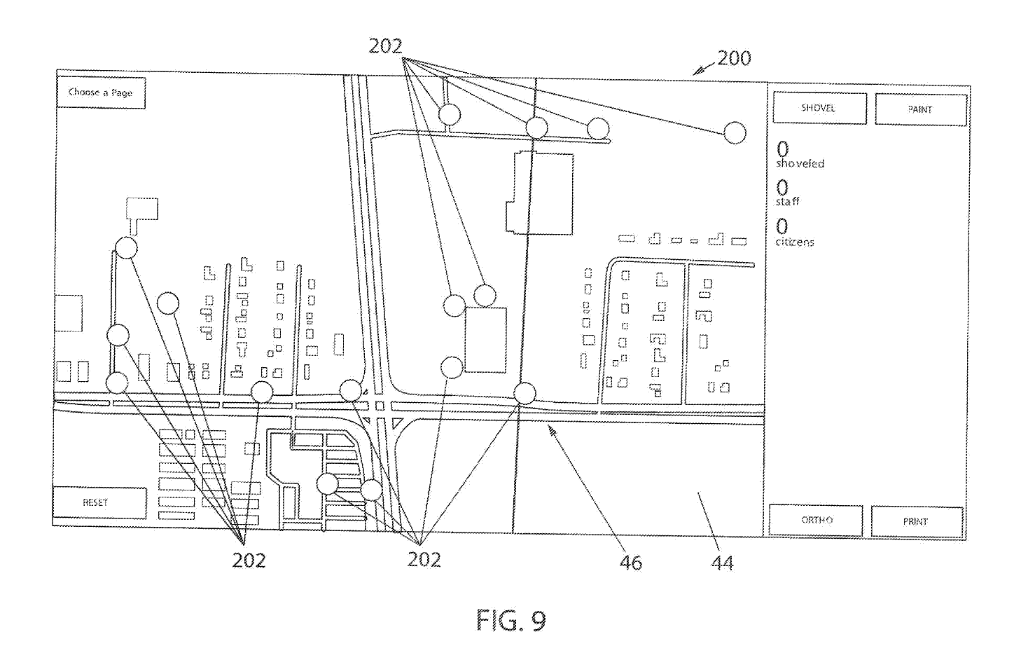

Referring now to FIG. 9, an exemplar map 200 with a plan 46 having multiple activities 202 distributed over a geographic area is provided in accordance with another aspect of the invention. In this aspect, the host system 30 can prepare a map 44 including a plan 46 having multiple activities 202 distributed over a geographic area. The plan 46 could be a snow removal plan for sections of a community represented by the map 44. However, instead of the devices 12 sending the reports 50 at the user's discretion, the sections of the community can have predetermined locations corresponding to the activities 202 for automatically retrieving report information from a device 12 upon encountering an activity 202. For example, as a snow plow truck encounters an activity 202 while plowing a street, the device 12 associated with the snow plow truck can be triggered by the activity 202 to immediately provide information from the device 12 to the host system 30. Such information could include, for example, distance travelled, route travelled, average speed, elapsed time, plow state (up or down), and the like. Information can be retrieved from devices 12, for example, similar to retrieval of payment information as used by electronic tollways. After parameters are retrieved, they can be linked to the corresponding activities 202 as parameters characterizing the project feature at the activities 202.

Although the best mode contemplated by the inventors of carrying out the present invention is disclosed above, practice of the above invention is not limited thereto. It will be manifest that various additions, modifications and rearrangements of the features of the present invention may be made without deviating from the spirit and the scope of the underlying inventive concept.

What is claimed is:

1. An electronic project management system comprising:
a portable electronic device having a position sensor, a user interface and a wireless communication system; and
an electronic host system in communication with the portable electronic device, the electronic host system having a processor executing a program stored in a non-transient medium operable to:
(a) prepare a map comprising a plan having a plurality of activities distributed over a geographic area;
(b) receive a message from the portable electronic device, the message including:
(i) a location determined by the position sensor;
(ii) a timestamp for the message; and
(iii) a parameter characterizing a project feature;
(c) determine a coordinate location on the map based on the location determined by the position sensor, and
(d) link the parameter characterizing the project feature to an activity of the plan using the determined coordinate location.

2. The system of claim 1, further comprising to receive the message from the portable electronic device when the portable electronic device is in proximity to an activity of the plan.

3. The system of claim 1, wherein an activity of the plan relates to a construction feature at a construction site.

4. The system of claim 1, wherein the position sensor is implemented by a Global Positioning System (GPS).

5. The system of claim 1, wherein the map is a Geographic Information System (GIS) map.

6. The system of claim 1, further comprising the message including at least one of a picture and a video characterizing the project feature.

7. The system of claim 6, wherein the portable electronic device is at least one of a smart phone and a tablet.

8. The system of claim 1, further comprising the electronic host system executing to display a plurality of coordinate locations on the map corresponding to a plurality of messages.

9. The system of claim 8, further comprising the electronic host system executing to display the coordinate location on the map with the parameter characterizing the project feature.

10. The system of claim 8, wherein the plan is a construction design plan, and further comprising the electronic host system executing to display the construction design plan in a first layer and the parameter characterizing the project feature in a second layer.

11. An electronic project management method comprising:
preparing a map comprising a plan having a plurality of activities distributed over a geographic area;
receiving a message from a portable electronic device, the portable electronic device having a position sensor, a user interface and a wireless communication system, the message including:
(i) a location determined by the position sensor;
(ii) a timestamp for the message; and
(iii) a parameter characterizing a project feature;
determining a coordinate location on the map based on the location determined by the position sensor; and
linking the parameter characterizing the project feature to an activity of the plan using the determined coordinate location.

12. The method of claim 11, further comprising receiving the message from the portable electronic device when the portable electronic device is in proximity to an activity of the plan.

13. The method of claim 11, wherein an activity of the plan relates to a construction feature at a construction site.

14. The method of claim 11, further comprising receiving at least one of a picture and a video characterizing the project feature in the message.

15. The method of claim 11, further comprising displaying a plurality of coordinate locations on the map corresponding to a plurality of messages.

16. The method of claim 15, further comprising displaying the coordinate location on the map with the parameter characterizing the project feature.

17. The method of claim 15, wherein the plan is a construction design plan, and further comprising displaying the construction design plan in a first layer and the parameter characterizing the project feature in a second layer.

18. A method for managing a construction project using a portable electronic device including a position sensor, a user interface, and a wireless communication system and an electronic host system connected to a network, the method comprising:
(a) sending a message from the portable electronic device to the electronic host system via the wireless communication system and the network, the message including a location determined by the position sensor and a parameter characterizing a construction feature at the location provided by the user interface; and
(b) linking the parameter characterizing the construction feature in the message to a coordinate location on a map, the coordinate location corresponding to the location in the message.

19. The method of claim 18, sending at least one of a picture and a video in the message from the portable electronic device being operable to send, the at least one of a picture and a video relating to the parameter characterizing the construction feature.

20. The method of claim 18, further comprising displaying a construction design plan on the map in a first layer and the coordinate location on the map with the parameter characterizing the construction feature in a second layer.
